(19) United States
(12) Patent Application Publication
(10) Pub. No.: US 2013/0276835 A1
(43) Pub. Date: Oct. 24, 2013

(54) Method and Apparatus to Clean Ash from Ash Ponds or a Landfill

(71) Applicants: Ove Lars Jepsen, Bethlehem, PA (US); John S. Salmento, Nazareth, PA (US); Peter Paone, North Catasauqua, PA (US)

(72) Inventors: Ove Lars Jepsen, Bethlehem, PA (US); John S. Salmento, Nazareth, PA (US); Peter Paone, North Catasauqua, PA (US)

(21) Appl. No.: 13/976,728

(22) PCT Filed: Dec. 28, 2011
(86) PCT No.: PCT/US2011/067451

§ 371 Date: Jun. 27, 2013

Related U.S. Application Data
(60) Provisional application No. 61/427,829, filed on Dec. 29, 2010.

(51) Int. Cl. B08B 7/00

(52) U.S. Cl. CPC B08B 7/0085
USPC 134/19

(57) ABSTRACT

A method of cleaning an ash material byproduct of a coal fired power plant of metal and hydrocarbon impurities. Dewatered feed material containing the ash material byproduct is preheated and crushed and then heated in a volatilizer to a temperature at which the metal and hydrocarbon impurities are volatilized. The ash is then separated from the volatilized materials.

### BACKGROUND OF THE INVENTION

The electric power industry in the United States and elsewhere is being pressured by various government agencies and environmental groups to eliminate ash and other coal fired power plant byproducts (alternatively referred to as byproducts of fossil fuel combustion, and/or wastes) currently stored in ponds located in the vicinity of such plants.

Given the actual damage caused by ash spills, the potential for future damage, and the added cost from expected new regulations, the electric power industry is actively seeking solutions to eliminate the problem. It is possible to remove the ash slurry in the ponds, thermally dry it, and then return the dry ash to a separate landfill. This solution is not ideal because it doesn't deal with heavy metals that may be present in the ash, and the material still needs to be stored as a waste. This solution also does not remove the possibility that the ash will be classified as a hazardous waste in the future.

A better way to deal with the ash slurry in these ponds is to process the ash so that it can be used as product in a commercial product, such as a feedstock for making concrete, road base, or flowable fill. This will eliminate or greatly reduce the long term landfill requirement, eliminate the possibility of the ash be classified as a hazardous waste, and generate some revenue from the sale of the product.

The method of the present invention is directed to cleaning the ash byproduct of solid fuel fired power plants, primarily coal. Such ash takes the form of “bottom ash”, which falls out of bottom of the furnace and is disposed in wet form such as by being conveyed to an ash pond in water, and “fly ash”, which is entrained in exhaust gases from furnaces. Fly ash is typically collected dry and is sent to landfills. Bottom ash is generally coarser and has a higher undesirable metal concentration than fly ash.

Reference is made to the drawings, in which similar numerals reference similar elements, thick solid lines the movement of solids and dotted lines the movement of gases.

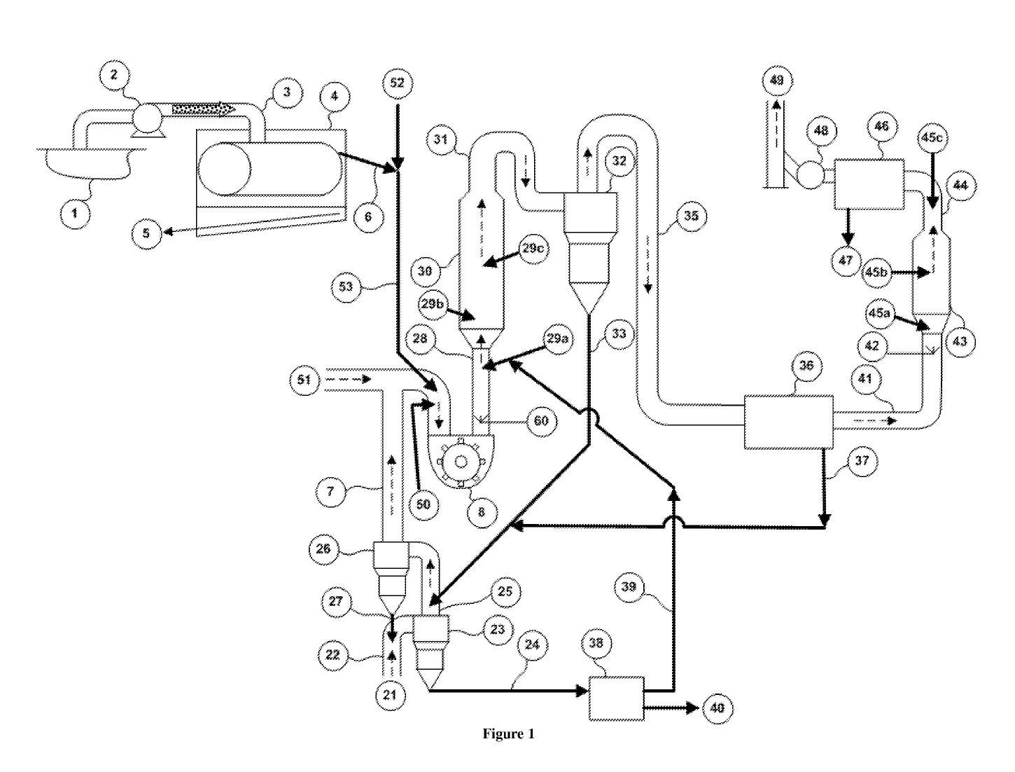

FIG. 1 is a diagram of a preferred embodiment of the invention.

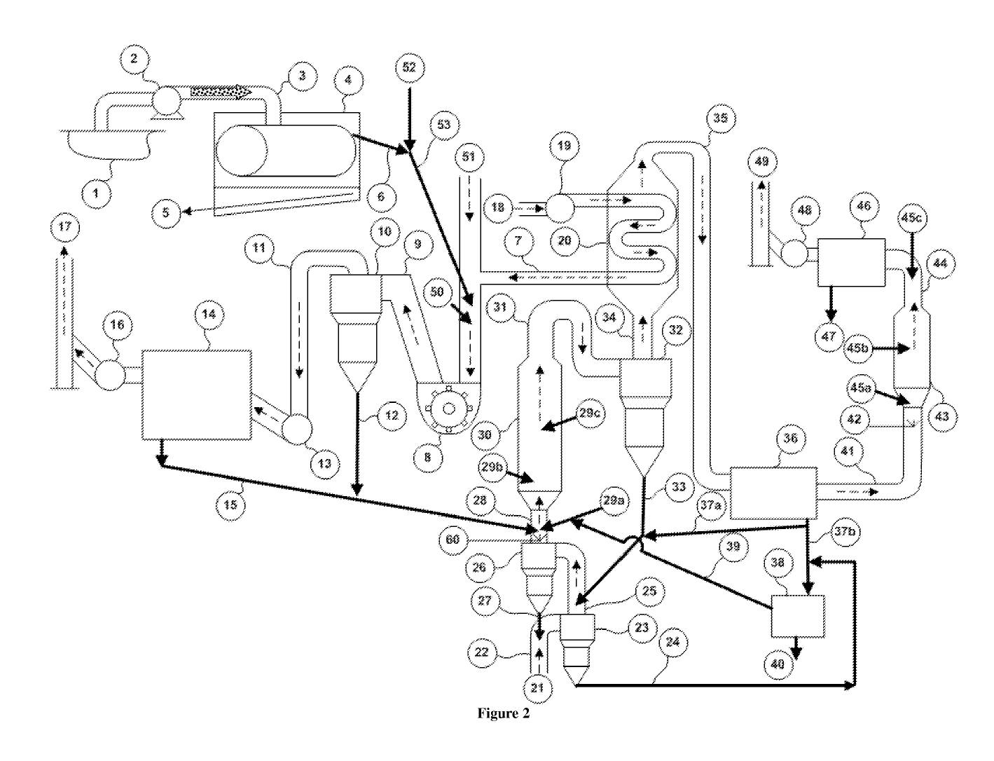

FIG. 2 is another embodiment of the invention.

The invention is primarily directed to recovering and cleaning bottom ash recovered from a land fill in a wet condition, although it is adaptable for use for cleaning fly ash from landfills.

With regard to FIG. 1, dewatered ash feed is inserted into the system at point 52. The ash can come from ash ponds, or, not as preferably, from landfills, or it can be a combination of material from ash ponds and land fills. It is also contemplated that the ash can be directly sent to the system of the present invention from power plants in either wet form, in which case it would be treated by the dewatering step described below, or in dry form.

In one embodiment all or a portion of the ash treated according to this invention is bottom ash from ash pond 1, which is a waste disposal ponds containing ash from solid fuel fired power plants. The ash ponds are generally located in the vicinity of the power plant, and the ash is usually pumped into the ponds via slurry pipeline

Ash can be removed from ash ponds 1 in the form of a slurry by pump 2 after which the slurry will flow through pipe 3 to mechanical dewatering device 4, with the ash/water slurry mixture being represented by the dotted arrow downstream from pump 2.

The slurry will have a solid content of from about 20% to about 80%. Factors that influence the solids content include the depth at which slurry is extracted from the pond or the relative location of the slurry from the inlet from the power plant, with deeper-lying slurries and slurries located closer to the plant inlet having a higher solids content. The slurry can also be removed from ash pond 1 with, for example, front end loaders or conveyors.

If the ash has too high a solids content to effectively be pumped out of the pond it can be diluted by water. In this regard, the slurry generally has to have at least a 50% water content to be effectively pumped out of the pond. In order to reach a desired water content when the slurry is too coarse for pumped, water 5 removed by the dewatering device 4 can be utilized to dilute the ash slurry.

The slurry is directed to a mechanical dewatering device 4 to reduce the free water content therein. Examples of suitable mechanical dewatering devices include a filter press, a belt press, a drum filter, a centrifuge and a disc filter. The slurry entering the mechanical dewatering device 4 via pipe 3 will have at least a 50% water content, and will typically be dewatering to about a 10% to about 25% water content.

Water will be removed from device 4 via conduit 5. The removed water can be used in a number of different ways. Some or all of such water can be sent back to pond 1 or it can be evaporated in an evaporation pond. Alternatively, some of the water can be utilized in the power plant or in other points in the process of the present invention—for example, it can be inserted at point 42 to cool the gas entering gas suspension absorber 43 and to thereby begin to condense some of the undesirable volatile metals and organic compounds. Any remaining water to be discharged into the environment may need to be first treated to remove metals and other impurities.

The dewatered ash slurry is directed to input 53 to the drier crusher 8. Alternatively the dewatered ash slurry can be combined with landfill ash or the present process can to used to just clean landfill ash. In the case of landfill ash, which generally has a lower water content than pond ash, the mechanical dewatering circuit will not be utilized. Landfill ash can also be combined, in cases where there is a very watery slurry, with pond ash upstream from the mechanical dewatering device. In any embodiment, bottom ash and/or fly ash from a power plant will be contaminated with carbon, mercury, other hazardous metals and/or organic compounds.

The dewatered ash is fed to drier crusher 8 for sufficient material drying, i.e. to remove free moisture, and disagglomeration/crushing of larger material. In drier crusher 8 the material is crushed to less than 5 mm and preheated and dried to a moisture content of from about 0.025% to about 2.5% by the hot gas in duct 7. In addition an optional source of hot air, which can be a byproduct of the operation of the power plant, can be directed into drier crusher 8 via inlet duct 51. Optional fuel can be added to the system for the drier/crusher, such as at point 50. The dried, crushed material is of a fineness suitable to be suspended and conveyed in a gas stream via riser 28 to the volatilizer 30, which as shown is an updraft vessel where the entrained dried, crushed material enters in the lower portion of the volatilizer entrained in combustion air. Fuel can be directed into the volatilizer through a single location or multiple locations 29a, 29b, and 29c. The volatilizer is maintained at a temperature sufficient to volatilize the undesirable components in the ash, preferably between about 275° C.-800° C., depending upon the composition of the ash material, and most preferably between about 350° C.-500° C. If heated to a sufficiently high temperature the pozzolanic properties of the ash material may be activated.

In the volatilizer the ash material will be dried to remove interpore moisture while volatilizing volatile organic compounds and metal compounds present in the ash including mercury. Depending upon the temperature at which the volatilizer is running, carbon may remain in the ash material and will be removed via downstream procedures. In addition, some of the undesirable compounds will be destroyed in the volatilizer if it is operated at a sufficiently high temperature.

Gas containing entrained cleaned ash and vaporized volatiles is directed via duct 31 to primary hot dust collector 32 that is designed to operate at high temperatures to maintain the volatile materials in a vaporized state during the collecting and separation process. Primary hot dust collector 32 may be a mechanical cyclone or other high temperature particulate collection device. Most of the ash will be separated from the hot gas in primary hot dust collector 32. The cleaned ash is subject to further processing and cooling by directing it via conduit 33 to an optional cooling cyclone/heat exchanger, which may be one stage or multiple stages, two stages 23 and 26 being depicted, where in duct 25 it will mix with ambient air from source 21/duct 22 as it exits stage 23. The cleaned ash will be cooled and in turn will increase the heat captured by the ambient air, and as a result will increase the temperature of the gas in duct 25 and thereafter in duct 7 from which the gas is directed into drier/crusher 8. As the number of stages of optional cooling cyclone/heat exchanger increases, the heat returned to the volatizer is increased and the fuel consumption will decrease.

Depending upon the temperature at which the ash is processed in volatilizer 30, carbon may still be present in the cleaned ash product. If that is the case, the cleaned cool ash can be directed from cooling cyclone/heat exchanger 23 via conduit 24 to optional carbon removal device 38 which can for example be an electrostatic belt separator. The removed carbon can be recycled via conduit 39 to be used as fuel in volatilizer 30. The cleaned ash is then recovered at 40 can be used as an additive to make concrete. If a two stage cooling cyclone/heat exchanger 23 and 26 is utilized separated product 27 from cooling cyclone 26 can also be sent to carbon removal device 38.

Gas exiting primary hot dust collector 32 can be directed via duct 35 to optional secondary hot dust collector 36, which is also designed to operate at a temperature to keep the volatile compounds volatilized and which can be, for example, a hot electrostatic precipitator. Secondary hot dust collector 36 is designed to collect most of the remaining very fine ash that escaped the primary hot dust collector 32. Typically, the minimum temperature of secondary hot dust collector 36 will be about 175° C. at its bottom end. Any cleaned ash separated by secondary hot dust collector 36 can be mixed with the cleaned ash exiting the cyclone preheater by being directed via conduit 37 to optional cooling cyclone/heat exchanger 23/26. Depending upon the heavy metal concentration in this very fine ash, it can also either be sent to disposal or returned to the volatilizer.

Gas containing undesirable volatilized compounds is directed via duct 41 to a device 43 for cooling the gas stream and removing mercury and other volatized pollutant material from the gas stream which may be a gas suspension absorber or conditioning tower. A gas suspension absorber is a form of semi-dry scrubber that utilizes a fluidized bed reactor after the hot dust collector or collectors to cool the gas, inject sorbents or chemical reagents, recycled sorbent or chemical reagents and recycled particulate material. An FLSmidth Airtech Gas Suspension Absorber can suitably be used in such an application. Nozzle means 42 is utilized to insert a spray of cooling liquid near the entrance of device 43 to initiate the cooling process and to cool the gas stream to a temperature where the heavy metals condense.

An agent that interacts with the mercury and other pollutants in the gas stream in the gas stream such as sorbents and/or chemical reagents, which can include activated carbon, is added to the cooling device 43 at one or more locations, such as via inlets 45a, 45b or 45c, and in any case upstream from dust collector 46, to thereby form a product of the agent/mercury interaction, with the formation of said product concurrently removing mercury from the gas stream. The reactivity and amount of sorbent or chemical reagent used in the present invention can be controlled by the type of sorbent or chemical reagent utilized, where the sorbent or chemical reagent is inserted relative to the second hot collector and/or the temperature profile of the gas in the area in which the sorbent or chemical reagent is injected. The removal of a contaminant may have a temperature window where removal is favored. In the case of mercury and mercury compounds using activated carbon or hydrated lime, adsorption will generally occur in the temperature window of about 20° C. to about 300° C., preferably about 80° C. to about 200° C., and will take place in the cooling device 43. The sorbent or chemical reagent containing contaminant 47 can be collected from activated carbon/mercury sorbent dust collector 46, which is a cold dust collector. Some of the spent sorbent 47 can be recycled back to 45 to be used for additional pollutant removal with the remainder being sent for disposal. Cleaned gas is forced up the stack 49 to atmosphere by ID fan 48.

Chemical additives may be optionally added, either upstream, downstream, or in the cooling device 43, to assist in converting the mercury to the oxidized form to aid in the readsorption of mercury when the sorbent or chemical reagent is added downstream of the first dust collector. Suitable oxidizing agents include ozone, peroxide, halogenated species such as a chlorine solution, potassium permanganate, hydrochloric acid, iodine and other agents suitable to oxidize mercury.

The preferred amount of oxidizing agent will typically be expressed as its concentration in the gas stream downstream from where the agent is injected. For example, when the oxidizing agent is chlorine the preferred concentration of chlorine in the gas stream will generally range from about 500 to about 10000 ppm.

In one embodiment oxidizing agents can be added upstream from volatilizer 30 such as into riser 28 at insert point 60. Inserting the oxidizing agents upstream from volatilizer 30 promotes the volatilization of hazardous metals so that a lower temperature is needed in the volatilizer.

FIG. 2 is another embodiment of the invention in which there is a separate circuit to separate the crushing drying process from the mercury/metal removal process. This embodiment is potentially more fuel efficient but more requires more capital expenditures than the system of FIG. 1.

The ash recovering process is the same in FIG. 2 as in FIG. 1. The crushed, dried ash is entrained in the gas stream and conveyed in duct 9 to dryer crusher cyclone 10 and then is directed via duct 11 to dust collector 14. The clean gas stream is sent to atmosphere via stack 17. Optional ID fans 13 and 16 are used to draw the air out to atmosphere. The recovered dry, crushed, unclean ash is sent via conduits 12 and 15 to volatilizer 30 in accordance with the process of FIG. 1.

FIG. 2 depicts another optional embodiment in which off gas from primary hot dust collector 32, prior to being sent to the volatile removal portion of the process, is sent to indirect gas to gas heat exchanger 20 to heat ambient air entering the heat exchanger at 18, optionally being drawn in by optional FD fan 19. The air heated in the heat exchanger is directed to dryer crusher 8 via duct 7. Care should be taken not to reduce the heat of the gas stream in the heat exchanger so much so the volatilized materials condense out of the gas stream. Any cleaned ash separated by secondary hot dust collector 36 can be directed via conduit 37a to optional cooling cyclone/heat exchanger 23/26. To promote temperature control, a portion of cleaned ash from secondary hot dust collector 36 can be sent directly to carbon removal device 38.

What is claimed is:

1. A method of cleaning an ash material byproduct of a coal fired power plant of metal and hydrocarbon impurities present in said ash comprising
crushing the ash material a to fineness suitable for the material to be suspended and conveyed in a gas stream;
directing the gas stream containing the suspended material to a heat treating device;
heat treating the material to a temperature at which the metal and hydrocarbon impurities are volatilized; and
separating the ash from the gas stream.

2. The method of claim 1 wherein ash material is collected from an ash pond.

3. The method of claim 1 wherein ash material is dewatered prior to the crushing step.

4. The method of claim 1 wherein ash material is collected from an ash pond.
